(19) United States
(12) Patent Application Publication
(10) Pub. No.: US 2016/0222255 A1
(43) Pub. Date: Aug. 4, 2016

(54) PRESSURE-SENSITIVE ADHESIVE SHEET FOR MOBILE ELECTRONIC DEVICES

(71) Applicant: NITTO DENKO CORPORATION, Ibaraki-shi ,Osaka (JP)

(72) Inventor: Masatsugu KOSO, Ibaraki-shi, Osaka (JP)

(73) Assignee: NITTO DENKO CORPORATION, Ibaraki-shi, Osaka (JP)

(21) Appl. No.: 15/021,842

(22) PCT Filed: Sep. 1, 2014
(86) PCT No.: PCT/JP2014/072907

§ 371 Date: Mar. 14, 2016

(30) Foreign Application Priority Data
Sep. 17, 2013 (JP) 2013-191583

(51) Int. Cl. C09J 7/02; C09J 133/14

(52) U.S. Cl. CPC C09J 7/0264; C09J 133/14; C09J 2201/128; C09J 2201/606; C09J 2433/00; C09J 2203/326

(57) ABSTRACT

Provided is a PSA sheet for mobile electronic devices that has excellent drop impact resistance while being capable of exhibiting great holding power. This invention provides an adhesively double-faced PSA sheet used for fastening a component of a mobile electronic device. The PSA sheet comprises a PSA layer formed from a water-dispersed PSA composition. The water-dispersed PSA composition comprises a PSA polymer as its base polymer and a crosslinking agent. The PSA polymer has a glass transition temperature of −60° C. or lower.

### TECHNICAL FIELD

The present invention relates to a pressure-sensitive adhesive (PSA) sheet for mobile electronic devices. In particular, it relates to an adhesively double-faced PSA sheet used for fastening a component of a mobile electronic device. The present application claims priority to Japanese Patent Application No. 2013-191583 filed on Sep. 17, 2013; and the entire contents thereof are incorporated herein by reference.

### BACKGROUND ART

For the excellent workability and handling properties, double-faced PSA sheets are widely used for purposes such as joining and fastening in various fields. For example, in mobile electronic devices including mobile phones and smartphones, they are favorably used for joining components such as display panels and cases. The mobile electronic devices are used in hand; and because of such forms of use, they may be dropped while in use, etc. Accordingly, drop impact resistance (an ability to prevent damage and failure of the main body against drop impact) is required of the mobile electronic devices. Technical literatures related to PSA sheets applied to mobile electronic devices include Patent Document 1.

### CITATION LIST

### Patent Literature

[Patent Document 1] Japanese Patent Application Publication No. 2005-187513

### SUMMARY OF INVENTION

### Technical Problem

Besides the drop impact resistance, various other adhesive properties may be required of a PSA sheet applied to mobile electronic devices as described above. Some of the PSA properties may be difficult to combine with drop impact resistance at a high level, such as, for instance, holding power which has a tendency to decrease with improving drop impact resistance. On the other hand, in recent years, from the standpoint of the environmental health, etc., water-dispersed PSA compositions having PSA particles dispersed in aqueous solvents are preferred to solvent-based PSA compositions formed with PSA ingredients dissolved in organic solvents. In general, however, with respect to PSA formed from a water-dispersed PSA composition, it is not easy to achieve properties equivalent to or greater than PSA formed from a solvent-based PSA composition. It is beneficial to provide a water dispersed PSA that can provide great holding power in addition to excellent drop impact resistance.

The present invention has been made in view of such circumstances. An objective thereof is to provide a PSA sheet for mobile electronic devices that has excellent drop impact resistance and is able to produce great holding power as well.

### Solution to Problem

The present invention provides an adhesively double-faced PSA sheet used for fastening a component of a mobile electronic device. The PSA sheet comprises a PSA layer formed from a water dispersed PSA composition. The water dispersed PSA composition comprises a PSA polymer as its base polymer and a crosslinking agent. The PSA polymer has a glass transition temperature of −60° C. or below. The PSA sheet having such a constitution may exhibit excellent drop impact resistance as well as great holding power.

The water-dispersed PSA composition disclosed herein preferably comprises an isocyanate-based crosslinking agent as the crosslinking agent. The use of the isocyanate-based crosslinking agent can combine drop impact resistance and holding power at a higher level. It may also improve the removability.

The PSA layer disclosed herein preferably has a weight ratio G_{B} of ethyl acetate-insoluble portion of 15% to 45%. When constituted in such a manner, it can combine drop impact resistance and holding power at a high level along with greater removability and repulsion resistance.

The PSA polymer disclosed herein is preferably an acrylic polymer. The use of the acrylic polymer as the base polymer can favorably combine drop impact resistance and holding power. The acrylic polymer is preferably obtained by polymerizing starting monomers (a starting monomer material) that comprise 50% by weight or more of an alkyl acrylate having an alkyl group with 5 to 10 carbon atoms.

The PSA sheet in the art disclosed herein preferably further comprises a substrate that supports the PSA layer. The substrate is preferably a resin film substrate. The PSA formed from the PSA composition disclosed herein may produce excellent anchoring (tight adhesion) to the resin film substrate. A PSA sheet using the resin film substrate has excellent workability and thickness precision.

The PSA sheet in the art disclosed herein preferably has a displacement distance of 2 mm or smaller from the initial position after one hour in a 40° C. holding power test carried out with a 500 g load applied. The PSA sheet that satisfies this property may exhibit excellent cohesive strength.

The PSA sheet in the art disclosed herein preferably exhibits a 180° peel strength to a polycarbonate plate of 10 N/20 mm or greater. The PSA sheet that satisfies this property has high adhesive strength and thus may firmly fasten a component of a mobile electronic device.

As described above, the PSA sheet disclosed herein can exhibit excellent drop impact resistance as well as great holding power; and therefore, it is suited for fastening components of mobile electronic devices. Thus, this description provides a mobile electronic device comprising at least two components and a PSA sheet (a PSA sheet disclosed herein) that fastens the at least two components.

### BRIEF DESCRIPTION OF DRAWINGS

FIG. 1 shows a cross-sectional view schematically illustrating a constitution example of the PSA sheet.

FIG. 2 shows a cross-sectional view schematically illustrating another constitution example of the PSA sheet.

FIG. 3 shows a cross-sectional view schematically illustrating another constitution example of the PSA sheet.

FIG. 4 shows a cross-sectional view schematically illustrating another constitution example of the PSA sheet.

FIGS. 5 (a) and (b) show diagrams schematically illustrating a repulsion resistance test method.

FIGS. 6 (a) and (b) show diagrams illustrating a test sample used in impact resistance test.

### DESCRIPTION OF EMBODIMENTS

Preferred embodiments of the present invention are described below. Matters necessary to practice this invention other than those specifically referred to in this description may be understood as design matters based on the conventional art in the pertinent field for a person of ordinary skill in the art. The present invention can be practiced based on the contents disclosed in this description and common technical knowledge in the subject field.

In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

The term “PSA” in this description refers to, as described earlier, a material that exists as a soft solid (a viscoelastic material) in a room temperature range and has a property to adhere easily to adherend with some pressure applied. As defined in “Adhesion Fundamental and Practice” by C. A. Dahlquist (McLaren & Sons (1966), P. 143), PSA referred to herein is a material that has a property satisfying complex tensile modulus E*(1 Hz)<10⁷ dyne/cm² (typically, a material that exhibits the described characteristics at 25° C.).

<Applications>

The PSA sheet disclosed herein is characterized in that it is used for fastening a component of a mobile electronic device. The mobile electronic device herein refers to electronic devices for portable use in general and is not particularly limited otherwise. In this description, to be “mobile (portable),” it is unsatisfactory to be simply capable of being carried. Instead, it indicates a level of mobility (portability) that allows for relatively easy carriage by hand of an individual (a typical adult). Typical examples of the mobile electronic device include mobile electronic devices installed with liquid crystal and other display devices, such as mobile phones, smartphones, tablet PCs and digital cameras. The PSA sheet disclosed herein combines drop impact resistance and holding power at a high level. Thus, for instance, in a mobile electronic device installed with a display device such as liquid crystal, it can be particularly preferably used for joining components (e.g. a display panel and a case) of the mobile electronic device.

### <PSA Polymer>

### (Properties of PSA Polymer)

The PSA layer (i.e. the water dispersed PSA composition used for forming the PSA layer) of the PSA sheet disclosed herein is characterized by the PSA polymer contained as the base polymer having a glass transition temperature (Tg) of −60° C. or below. With the use of the PSA polymer having such a Tg, the PSA sheet can achieve excellent drop impact resistance. The adhesive strength tends to increase as well. The Tg is more preferably −62° C. or below (e.g. −64° C. or below, typically −66° C. or below). The lower limit of the Tg is not particularly limited. From the standpoint of the ease of production and availability, it is usually preferably −75° C. or above.

The Tg of a PSA polymer in this description refers to the value determined by the Fox equation based on the Tg values of homopolymers of the respective monomers and the weight fractions (copolymerization ratio by weight) of the monomers with respect to the monomer composition corresponding to the polymer. In the present description, numerical values indicating glass transition temperatures are in “° C.” unless otherwise informed.

As the Tg values of the homopolymers, values given in a known document are used. In the art disclosed herein, as the Tg values of the homopolymers, the following values are used specifically:

| | | |
|---|---|---|
| 2-ethylhexyl acrylate | −70° | C. |
| n-butyl acrylate | −55° | C. |
| ethyl acrylate | −20° | C. |
| methyl acrylate | 8° | C. |
| methyl methacrylate | 105° | C. |
| isobornyl acrylate | 94° | C. |
| isobornyl methacrylate | 180° | C. |
| vinyl acetate | 32° | C. |
| 2-hydroxyethyl acrylate | −15° | C. |
| styrene | 100° | C. |
| acrylic acid | 106° | C. |
| methacrylic acid | 228° | C. |

With respect to the Tg values of homopolymers other than the examples listed above, the values given in “Polymer Handbook” (3rd edition, John Wiley & Sons, Inc., Year 1989) are used.

When no values are given in the “Polymer Handbook” (3rd edition, John Wiley & Sons, Inc., Year 1989), values obtained by the following measurement method are used (see Japanese Patent Application Publication No. 2007-51271).

In particular, to a reaction vessel equipped with a thermometer, a stirrer, a nitrogen inlet and a condenser, are added 100 parts by weight of monomer, 0.2 part by weight of azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by weight solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and while applying a shear strain at a frequency of 1 Hz using a rheometer (ARES, available from Rheometrics Scientific, Inc.), the viscoelasticity is measured in the shear mode over a temperature range of −70° C. to 150° C. at a heating rate of 5° C./min; and the temperature value at the maximum of the loss modulus G″ curve is taken as the Tg of the homopolymer.

The PSA polymer disclosed herein preferably has a weight ratio G_{A} of ethyl acetate-insoluble portion in a range of 10% to 50%. In this description, G_{A} is thought as an index that indicates the degree of entanglement of the PSA polymer itself. Thus, a high G_{A} means that the PSA polymer has an aggregate structure with a high degree of entanglement. The aggregate structure based on such entanglement of the PSA polymer has a high ability to relieve stress as compared to a chemically crosslinked structure formed with a crosslinking agent, etc. Thus, it contributes to reduce the lowering of repulsion resistance. On the other hand, too high a G_{A} tends to decrease the PSA properties (typically the adhesive strength) of the crosslinked PSA finally obtained. The repulsion resistance tends to decrease as well. When the art disclosed herein is implemented using a crosslinking agent, too high a G_{A} relatively reduces the contribution of the chemically crosslinked structure (e.g. chemically crosslinked structure formed with an isocyanate-based crosslinking agent) in the gel fraction of the crosslinked PSA; and, for instance, in fabricating a PSA sheet using a substrate such as resin film, the anchoring to the substrate may be insufficient, decreasing the removability. The G_{A} is more preferably 12% or higher (e.g. 15% or higher, typically 17% or higher). The G_{A} is more preferably 40% or lower (e.g. 30% or lower, typically 20% or lower). The G_{A} can be adjusted by the molecular weight and monomer composition of the PSA polymer, the type and amount of polymerization initiator, the type and amount of surfactant, the type and amount of chain transfer agent, etc. The G_{A} is measured by the next method. The same applies to the G_{A} in Examples described later.

[Method for Measuring Weight Ratio G_{A} of Ethyl Acetate-Insoluble Portion of PSA Polymer]

Approximately 0.1 g of a PSA polymer (weight W1) is wrapped into a pouch with a porous polytetrafluoroethylene membrane (weight W2) having an average pore diameter of 0.2 μm. The opening is tied with twine (weight W3). The package is immersed in 50 mL of ethyl acetate and stored at room temperature (typically 23° C.) for 7 days to extract out only the sol fraction of the PSA layer from the membrane. After this, the package is taken out, and any residual ethyl acetate is wiped off the outer surface. The package is then dried at 130° C. for 2 hours and the package weight (W4) is measured. G_{A} is determined by substituting the respective values into the following equation:

G_{A} (%)=[(W4−W2−W3)/W1]×100

As the porous polytetrafluoroethylene (PTFE) membrane, it is desirable to use trade name NITOFURON® NTF1122 (0.2 μm average pore diameter, 75% porosity, 85 μm thick) available from Nitto Denko Corporation or a similar product.

The weight average molecular weight (Mw) of the ethyl acetate-soluble portion (sol fraction) of the PSA polymer disclosed herein is not particularly limited. It is preferably larger than 65×10⁴ (e.g. larger than about 85×10⁴, typically larger than 100×10⁴). The use of the PSA polymer having such a Mw tends to improve the removability, repulsion resistance and holding power in a well-balanced manner. The upper limit of the Mw is not particularly limited. It is preferably about 200×10⁴ or smaller (e.g. 180×10⁴ or smaller). The number average molecular weight (Mn) of the ethyl acetate-soluble portion (sol fraction) of the PSA polymer is not particularly limited, either. For the same reason as the Mw, it is preferably in a range of about 10×10⁴ to 40×10⁴ (e.g. 15×10⁴ to 30×10⁴, typically 20×10⁴ to 25×10⁴). From the standpoint of improving the removability, repulsion resistance and holding power in a well-balanced manner, Mw/Mn is preferably 3 or greater (e.g. 3.5 or greater, typically 4 or greater). The upper limit of Mw/Mn is not particularly limited. It may be usually about 7 or less. In this description, the Mw and Mn of the ethyl acetate-soluble portion of the PSA polymer refer to the weight average molecular weight and number average molecular weight, respectively, based on standard polystyrene determined by gel permeation chromatography (GPC) analysis of a measurement sample (typically the sol fraction). Specifically, the Mw and Mn are measured by the next method. The same applies to the Mw and Mn in Examples described later.

[Method for Measuring Weight Average Molecular Weight (Mw) and Number Average Molecular Weight (Mn)]

In ethyl acetate, the PSA polymer is immersed at room temperature for 7 days to dissolve soluble components. The extract of the soluble components is dried to obtain a measurement sample. A measurement sample can also be obtained, for instance, by drying the extract (sol fraction) after measurement of weight ratio G_{A} of the ethyl acetate-insoluble portion of the PSA polymer. The measurement sample is dissolved again in tetrahydrofuran (THF) to prepare a 0.1% (by weight) THF solution. The THF solution is filtered with a filter having an average pore diameter of 0.45 μm and with respect to the resulting filtrate (sample solution for molecular weight measurement), the Mw and Mn based on standard polystyrene are determined by GPC measurement system. As the GPC measurement system, model name HLC-8220 GPC available from Tosoh Corporation can be used. The measurement conditions can be as follows:

[GPC Measurement Conditions]

Column: TSK gel GMH HR-H20

Detector: differential refractometer

Eluent: THF

Flow rate: 0.6 mL/min

Measurement temperature: 40° C.

Sample injection volume: 100 μL

### (Constitution of PSA Polymer)

As the PSA polymer disclosed herein, one, two or more species can be used among various polymers such as acrylic polymers, rubber-based polymers, polyester-based polymers, urethane-based polymers, polyether-based polymers, silicone-based polymers, polyamide-based polymers and fluorine-based polymers that are known in the PSA field. From the standpoint of the PSA properties, costs, etc., as the PSA polymer, a rubber-based polymer or an acrylic polymer can be preferably used. Among them, an acrylic polymer is particularly preferable.

The “base polymer” of a PSA refers to the primary component among rubbery polymers contained in the PSA. The term “rubbery polymer” refers to a polymer that exhibits rubber elasticity in a temperature range near room temperature. The term “primary component” in the present description refers to a component at a concentration exceeding 50% by weight unless otherwise specified.

The term “acrylic polymer” refers to a polymer comprising, as a monomeric unit constituting the polymer, a monomeric unit derived from a monomer having at least one (meth)acryloyl group per molecule. In the following, a monomer having at least one (meth)acryloyl group per molecule may be called “acrylic monomer”. The acrylic polymer in this description is defined as a polymer comprising a monomeric unit derived from an acrylic monomer. Typical examples of such an acrylic polymer include an acrylic polymer whose monomer composition contains an acrylic monomer at higher than 50% by weight.

The “(meth)acryloyl” comprehensively refers to acryloyl and methacryloyl. Similarly, the terms “(meth)acrylate” and “(meth)acryl” comprehensively refer to acrylate and methacrylate, and acryl and methacryl, respectively. The term “(cyclo)alkyl” comprehensively refers to acyclic alkyl and cycloalkyl.

As the acrylic polymer, for example, a polymer of a monomeric starting material comprising an alkyl (meth)acrylate as a primary monomer and possibly comprising a secondary monomer copolymerizable with the primary monomer is preferable. The primary monomer herein refers to a component that accounts for higher than 50% by weight of the monomer composition in the monomeric starting material.

As the alkyl (meth)acrylate, for instance, a compound represented by the following formula (1) can preferably be used:

CH₂═C(R¹)COOR² (1)

Herein, R¹ in the formula (1) is a hydrogen atom or a methyl group. R² is a acyclic alkyl group having 1 to 20 carbon atoms (hereinafter, such a range of the number of carbon atoms may be indicated as “C₁₋₂₀”). From the standpoint of the storage elastic modulus of PSA, an alkyl (meth)acrylate having a C₁₋₁₄ (e.g. C₁₋₁₀, typically C₄₋₁₀ acyclic alkyl group for R² is preferable. An alkyl acrylate having a hydrogen atom for R¹ and a C₅₋₁₀ (e.g. C₆₋₉, typically C₈) acyclic alkyl group for R² (or simply a C₅₋₁₀ alkyl acrylate hereinafter) is more preferable.

Examples of an alkyl (meth)acrylate with R² being a C₁₋₂₀ acyclic alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, etc. Among these alkyl (meth)acrylates, can be used one species solely or a combination of two or more species. Preferable alkyl (meth)acrylates include n-butyl acrylate (BA) and 2-ethylhexyl acrylate (2EHA). Among them, 2EHA is particularly preferable.

The primary monomer content in all the monomers is preferably 70% by weight or higher, more preferably 90% by weight or greater, or yet more preferably 95% by weight or greater. The upper limit of the primary monomer content is not particularly limited. It is preferably 99.5% by weight or less (e.g. 99% by weight or less). The acrylic polymer may be obtained by polymerizing essentially only the primary monomer. When a C₅₋₁₀ alkyl acrylate is included as the primary monomer, the C₅₋₁₀ alkyl acrylate content in the primary monomer is preferably 70% by weight or greater, more preferably 90% by weight or greater, or yet more preferably 95% by weight or greater (typically 99% to 100% by weight). The art disclosed herein can be preferably implemented in an embodiment where 2EHA accounts for 50% by weight or more (e.g. 70% by weight or more, typically 95% by weight or more) of the monomer composition of the starting monomers.

The secondary monomer copolymerizable with the alkyl (meth)acrylate being the primary monomer is useful for introducing crosslinking points in the acrylic polymer or increasing the cohesive strength of the acrylic polymer. As the secondary monomer, for instance, the following functional group-containing monomers can be used singly as one species or in a combination of two or more species:

Carboxyl group-containing monomers: for example, ethylenic unsaturated mono-carboxylic acids such as acrylic acid, methacrylic acid, crotonic acid, etc.; ethylenic unsaturated dicarboxylic acids such as maleic acid, itaconic acid, citraconic acid, as well as anhydrides thereof (maleic acid anhydride, itaconic acid anhydride, etc.).

Hydroxyl group-containing monomers: for example, hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, etc.; unsaturated alcohols such as vinyl alcohol, allyl alcohol, etc.

Amide group-containing monomers: for example, (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide.

Amino group-containing monomers: for example, aminoethyl (meth)acrylate, N,N-dimethylaminoethyl (meth)acrylate, t-butylaminoethyl (meth)acrylate.

Epoxy group-containing monomers: for example, glycidyl (meth)acrylate, methylglycidyl (meth)acrylate, allyl glycidyl ether.

Cyano group-containing monomers: for example, acrylonitrile, methacrylonitrile.

Keto group-containing monomers: for example, diacetone (meth)acrylamide, diacetone (meth)acrylate, vinyl methyl ketone, vinyl ethyl ketone, allyl acetoacetate, vinyl acetoacetate.

Monomers having nitrogen atom-containing rings: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloyl morpholine.

Alkoxysilyl group-containing monomers: for example, (3-(meth)acryloxypropyl)trimethoxysilane, (3-(meth)acryloxypropyl)triethoxysilane, (3-(meth)acryloxypropyl)methyldimethoxysilane, (3-(meth)acryloxypropyl)methyldiethoxysilane.

As the secondary monomer, a carboxy group-containing monomer is preferably used. The carboxy group-containing monomer is more preferably acrylic acid or methacrylic acid. The art disclosed herein may be practiced to produce the desired effects of the present invention even in an embodiment where the starting monomers used in the polymerization to obtain the acrylic polymer are free of a hydroxy group-containing monomer and/or a nitrogen atom-containing monomer (e.g. a monomer having a nitrogen atom-containing ring).

The amount of the secondary monomer can be suitably selected so as to obtain desirable cohesive strength with no particular limitations. Usually, from the standpoint of combining cohesive strength and other PSA properties (e.g. adhesive strength) in a well-balanced manner, the amount of the secondary monomer is suitably 0.5% by weight or more of all the monomers in the acrylic polymer, or preferably 1% by weight or more. The amount of the secondary monomer is suitably 30% by weight or less of all the monomers, or preferably 10% by weight or less (e.g. 5% by weight or less).

For the purpose of increasing the cohesive strength of the acrylic polymer, etc., other co-monomer(s) besides the aforementioned secondary monomers can be used. Examples of such co-monomers include vinyl ester-based monomers such as vinyl acetate, vinyl propionate; aromatic vinyl compounds such as styrene, substituted styrenes (α-methylstyrene, etc.), vinyl toluene; cycloalkyl (meth)acrylates such as cyclohexyl (meth)acrylate, cyclopentyl (meth)acrylate, isobornyl (meth)acrylate; aromatic ring-containing (meth)acrylates such as aryl (meth)acrylate (e.g. phenyl (meth)acrylate), aryloxyalkyl (meth)acrylate (e.g. phenoxyethyl (meth)acrylate), arylalkyl (meth)acrylate (e.g. benzyl (meth)acrylate); olefinic monomers such as ethylene, propylene, isoprene, butadiene, isobutylene; chlorine-containing monomers such as vinyl chloride, vinylidene chloride; isocyanate group-containing monomers such as 2-(meth)acryloyloxyethyl isocyanate; alkoxy group-containing monomer such as methoxyethyl (meth)acrylate, ethoxyethyl (meth)acrylate; vinyl ether-based monomers such as methyl vinyl ether, ethyl vinyl ether; and the like. The amount of such other co-monomer(s) can be suitably selected according to the purpose and intended use, and thus is not particularly limited. For instance, it is preferable to be 20% by weight or less of the monomer composition of the acrylic polymer.

The method for polymerizing the monomers or their mixture is not particularly limited. A heretofore known general polymerization method can be employed. As such a polymerization method, for instance, emulsion polymerization can be preferably used. The embodiment of polymerization is not particularly limited and can be carried out by suitably selecting a heretofore known monomer supply method, polymerization conditions (temperature, time, pressure, etc.) and other components (polymerization initiator, surfactant (emulsifier), etc.) besides the monomers. For example, as the monomer supply method, the entire monomer mixture may be supplied at once to a reaction vessel (all-at-once supply), gradually supplied dropwise (continuous supply), or divided into several portions and supplied portion-wise at every predetermined time (portion-wise supply). The monomers or their mixture are preferably supplied as a dispersion in which they are partially or entirely emulsified in water.

### (Polymerization Initiator)

For the polymerization to obtain the PSA polymer (preferably an acrylic polymer), in accordance with the polymerization method type, etc., a commonly known or used polymerization initiator can be suitably selected and used. From the standpoint of the stress relief of the PSA, in emulsion polymerization, an azo-based polymerization initiator can be preferably used. Specific examples of azo-based polymerization initiators include 2,2′-azobisisobutyronitrile (AIBN), 2,2′-azobis(2-methylpropionamidine) Bisulfate, 2,2′-azobis(2-amidinopropane) dihydrochloride, 2,2′-azobis[2-(5-methyl-2-imidazolin-2-yl)propane] dihydrochloride, 2,2′-azobis(N,N-dimethyleneisobutylamidine), 2,2′-azobis[N-(2-carboxyethyl)-2-methylpropionamidine] hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methylpropionate), and the like.

Other examples of polymerization initiators include persulfate salts such as potassium persulfate (KPS), ammonium persulfate (APS); peroxide-based initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane, hydrogen peroxide; substituted-ethane-based initiators such as phenyl-substituted ethane; carbonyl-based initiators such as aromatic carbonyl compounds; and so on. Yet other examples of polymerization initiators include a redox-based initiator by combination of a peroxide and a reducing agent. Examples of such a redox-based initiator include combination of a peroxide (hydrogen peroxide water, etc.) and ascorbic acid, combination of a persulfate salt and sodium hydrogen sulfite, and the like. These polymerization initiators can be used singly as one species or in combination of two or more species.

The amount of polymerization initiator used is not particularly limited. To 100 parts by weight of the starting monomers, for instance, the polymerization initiator can be used in an amount selected from a range of typically about 0.005 to 1 part by weight, or preferably about 0.01 to 1 part by weight. The polymerization temperature can be suitably selected according to the types of monomers and the type of polymerization initiator used, etc. Usually, the polymerization temperature is suitably about 20° C. to 100° C., or preferably about 40° C. to 80° C.

### (Surfactant)

Emulsion polymerization of the starting monomers is usually carried out in the presence of a surfactant (emulsifier). As the surfactant, a known anionic surfactant, nonionic surfactant and the like can be used. A surfactant having a radically polymerable functional group can be used as well. Hereinafter, the surfactant having a radically polymerizable functional group is referred to as a reactive (polymerizable) surfactant. On the contrary to this, a general surfactant free of a radically polymerizable functional group may be referred to as a non-reactive (non-polymerizable) surfactant. For the surfactant, solely one species or a combination of two or more species can be used.

Examples of a non-reactive anionic surfactant include alkyl sulfates such as lauryl sulfate and octadecyl sulfate; aliphatic acid salts; alkyl benzene sulfonates such as nonyl benzene sulfonate and dodecyl benzene sulfonate; naphthalene sulfonates such as dodecyl naphthalene sulfonate; alkyl diphenyl ether disulfonates such as dodecyl diphenyl ether disulfonate; polyoxyethylene alkyl ether sulfates such as polyoxyethylene octadecyl ether sulfate and polyoxyethylene lauryl ether sulfate; polyoxyethylene alkyl phenyl ether sulfates such as polyoxyethylene lauryl phenyl ether sulfate; polyoxyethylene styrenated phenyl ether sulfate; sulfosuccinates such as lauryl sulfosuccinate and polyoxyethylene lauryl sulfosuccinate; polyoxyethylene alkyl ether phosphates; and polyoxyethylene alkyl ether acetates and the like. When the anionic surfactant is forming a salt, the salt can be, for instance, a metal salt (preferably a monovalent metal salt) such as the sodium salt, potassium salt, calcium salt and magnesium salt; ammonium salt; amine salt, or the like.

Examples of a non-reactive nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan fatty acid esters such as sorbitan monolaurate, sorbitan monostearate and polyoxyethylene sorbitan monolaurate; polyoxyethylene glyceryl ether fatty acid esters; and polyoxyethylene-polyoxypropylene block copolymers and the like.

The reactive surfactant is not particularly limited as far as it has a radically polymerizable functional group. For instance, the reactive surfactant may have a structure such that a radically polymerizable functional group is incorporated in an aforementioned anionic surfactant or nonionic surfactant. From the standpoint of the emulsifying ability, etc., an anionic reactive surfactant can be preferably used. The type of radically polymerizable functional group is not particularly limited. For instance, it can be an alkenyl group, acryloyl group, methacryloyl group, etc. Specific examples of the alkenyl group include propenyl groups and isopropenyl group (CH₂═C(CH₃)—). The concept of propenyl group referred to herein encompasses 1-propenyl group (CH₃—CH═CH—) and 2-propenyl group (CH₂═CH—CH₂— which may be called allyl group). The radically polymerizable functional group is preferably an allyl group.

Examples of an anionic reactive surfactant include ammonium polyoxyethylene (allyloxymethyl) alkyl ether sulfate, ammonium polyoxyethylene nonyl propenyl phenyl ether sulfate, sodium alkyl allyl sulfosuccinate, sodium methacryloxy polyoxypropylene sulfate, ammonium polyoxyalkylene alkenyl ether sulfate (e.g. a compound having an isopropenyl group as the terminal alkenyl group) and the like. When the anionic reactive surfactant is forming a salt, the salt can be, for instance, a metal salt such as the sodium salt, ammonium salt, amine salt, or the like. In particular, from the standpoint of adjusting the G_{A} of the PSA polymer (e.g. an acrylic polymer), a sodium alkyl allyl sulfosuccinate is preferable.

Examples of a nonionic reactive surfactant include polyoxyethylene nonyl propenyl phenyl ether.

Commercial reactive surfactants include products of Dai-ichi Kogyo Seiyaku Co., Ltd., under trade names AQUALON HS-10, AQUALON HS-1025, AQUALON HS-20, AQUALON KH-10, AQUALON KH-1025, AQUALON KH-05, AQUALON BC-0515, AQUALON BC-10, AQUALON BC-1025, AQUALON BC-20, AQUALON BC-2020, AQUALON RN-20, AQUALON RN-30 and AQUALON RN-50; ADEKA products under trade names ADEKARIA SOAP SE-10N and ADEKARIA SOAP SR-1025; Kao Corporation products under trade names LATEMULE PD-104, LATEMULE PD-420, LATEMULE PD-430 and LATEMULE PD-450; products of Sanyo Chemical Industries, Ltd., under trade names ELEMINOL JS-20 and ELEMINOL RS-3000; and a product of Nippon Nyukazai Co., Ltd., under trade name ANTOX MS-60 and the like.

By carrying out emulsion polymerization of the starting monomers in the presence of a reactive surfactant having a radically polymerizable functional group, the reactive surfactant may undergo a reaction to be incorporated into the acrylic polymer. The reactive surfactant incorporated in the acrylic polymer is limited in mobility within the PSA layer and thus is unlikely to bleed to the PSA layer surface. Accordingly, the use of the reactive surfactant can reduce bleeding of a low molecular weight compound to the PSA layer surface. This is preferable from the standpoint of reducing degradation of PSA properties caused by the emulsifier. From the standpoint of obtaining greater PSA properties, it is preferable to apply an embodiment using solely a reactive surfactant as the surfactant for emulsion polymerization.

The amount of the surfactant used is not particularly limited. In view of the polymerization stability as well as the dispersion stability and anti-contamination properties of the polymerization product, etc., the amount of the surfactant used in emulsion polymerization is usually suitably about 0.1 to 5 parts by weight relative to 100 parts by weight of all the monomers, or preferably about 0.5 to 4 parts by weight.

For the polymerization, as necessary, various heretofore known chain transfer agents (which can be considered also as a molecular weight-adjusting agent or polymerization degree-adjusting agent) can be used. The chain transfer agent can be one, two or more species selected from mercaptans such as n-dodecanethiol, t-dodecanethiol, glycidyl mercaptan, 2-mercaptoethanol. Particularly preferable chain transfer agents include n-dodecanethiol and t-dodecanethiol. The amount of chain transfer agent used is not particularly limited. For instance, relative to 100 parts by weight of the monomeric starting material, it can be about 0.001 to 0.5 part by weight or it is usually preferably 0.01 to 0.1 part by weight.

When the water dispersed PSA composition disclosed herein comprises an acrylic polymer as the base polymer, in addition to the acrylic polymer, it may comprise a non-acrylic polymer. Preferable examples of the non-acrylic polymer include the various polymers exemplified as the PSA polymer while excluding the acrylic polymers. When the PSA layer (or the water-dispersed PSA composition) disclosed herein comprises a non-acrylic polymer in addition to the acrylic polymer, the non-acrylic polymer content to 100 parts by weight of the acrylic polymer is suitably 100 parts by weight or less, preferably 50 parts by weight or less, more preferably 30 parts by weight or less, or yet more preferably 10 parts by weight or less. The non-acrylic polymer content to 100 parts by weight of the acrylic polymer can be 5 parts by weight or less, or even 1 part by weight or less. The art disclosed herein can be preferably practiced, for instance, in an embodiment where the acrylic polymer accounts for 99.5% to 100% by weight of the PSA polymer.

### <Water-Dispersed PSA Composition>

### (Crosslinking Agent)

The water-dispersed PSA composition disclosed herein comprises a crosslinking agent in addition to the PSA polymer. With the inclusion of the crosslinking agent, drop impact resistance and holding power can be combined at a high level. As the crosslinking agent, one, two or more species of crosslinking agent generally used in the field of water-dispersed PSA compositions can be preferably used, such as an isocyanate-based crosslinking agent, epoxy-based crosslinking agent, oxazoline-based crosslinking agent, aziridine-based crosslinking agent and metal chelate-based crosslinking agent. In particular, the water dispersed PSA composition preferably comprises an isocyanate-based crosslinking agent. In the PSA formed from the water-dispersed PSA composition, chemical crosslinks formed with the isocyanate-based crosslinking agent at a specific ratio bring about improved removability in addition to increased holding power. Especially, to a resin film substrate such as polyester (typically polyethylene terephthalate (PET)), the PSA layer formed by providing the water dispersed PSA composition disclosed herein shows excellent anchoring (tight adhesion). The art disclosed herein can also be preferably implemented in an embodiment essentially free of other crosslinking agents besides the isocyanate-based crosslinking agent.

As the isocyanate-based crosslinking agent, it is desirable to use a polyisocyanate-based crosslinking agent having two or more isocyanate groups (isocyanate groups having protecting groups; e.g. possibly isocyanate-forming functional groups whose isocyanate groups are temporarily protected via treatment with a blocking agent, multimerization, etc.). The number of isocyanate groups per molecule of the polyisocyanate-based crosslinking agent is preferably 2 to 10 (e.g. 2 to 4, typically 2 or 3).

Examples of the polyisocyanate-based crosslinking agent include aromatic polyisocyanates such as tolylene diisocyanate and xylene diisocyanate; alicyclic isocyanates such as isophorone diisocyanate; and aliphatic polyisocyanates such as hexamethylene diisocyanate. More specific examples include lower aliphatic polyisocyanates such as butylene diisocyanate and hexamethylene diisocyanate; alicyclic polyisocyanates such as cyclopentylene diisocyanate, cyclohexylene diisocyanate and isophorone diisocyanate; aromatic diisocyanates such as 2,4-tolylene diisocyanate, 4,4′-diphenylmethane diisocyanate, xylylene diisocyanate and polymethylene polyphenyl diisocyanate; isocyanate adducts such as trimethylolpropane/tolylene diisocyanate trimer adduct (trade name CORONATE L available from Nippon Polyurethane Industry Co., Ltd.), trimethylolpropane/hexamethylene diisocyanate trimer adduct (trade name CORONATE HL available from Nippon Polyurethane Industry Co., Ltd.) and hexamethylene diisocyanate isocyanurate (available from Nippon Polyurethane Industry, Co., Ltd.; trade name CORONATE HX); polyisocyanates such as polyether polyisocyanate and polyester polyisocyanate; adducts of these polyisocyanates and polyols; and polyfunctionalization products of these polyisocyanates with isocyanurate bonds, biuret bonds, allophanate bonds, etc.

The art disclosed herein uses a water dispersed PSA composition; and therefore, an aqueous isocyanate-based crosslinking agent can be preferably used as the isocyanate-based crosslinking agent. Examples of the aqueous isocyanate-based crosslinking agent include self-emulsifying polyisocyanate, water-dispersible polyisocyanate and water-dispersible block isocyanate. Usually, isocyanate groups (NCO groups) can react with water over time. Thus, they are poorly stable in water. However, with respect to an aqueous isocyanate-based crosslinking agent as described above, for instance, with protection or the use of a dispersing agent, etc., its isocyanate group is fairly stable in water, and it is also highly dispersible in an aqueous solvent. Thus, it is preferable as the crosslinking agent used in the water dispersed PSA composition.

Among the aqueous isocyanate-based crosslinking agents, it is more preferable to use a water-stable isocyanate-based crosslinking agent. In this description, the “water stable isocyanate-based crosslinking agent” refers to an isocyanate-based crosslinking agent having properties (water stability) such that the isocyanate group remains even after 5 hours from the start of measurement in an isocyanate water stability test measured by the following method. The isocyanate water stability test is carried out by obtaining a 20% (by weight) aqueous solution of the isocyanate-based crosslinking agent to be tested, sampling the aqueous solution for quantification of isocyanate groups in the aqueous solution at the start of the measurement and after specific time periods (e.g. at 1 to 5 hour intervals) from the start of the measurement, and determining the ratio of the amount of isocyanate groups (ratio (%) of remaining isocyanate groups) after the specific time periods to the amount of isocyanate groups at the start of measurement. The start of measurement is when the isocyanate-based crosslinking agent is mixed with water (ion-exchanged water) and stirred for five minutes. The test can be carried out at a temperature of 25° C. Isocyanate groups in the aqueous solution can be quantified by a heretofore known method (e.g. infrared absorption spectroscopy).

In the isocyanate water stability test, it is preferable that for the water-stable isocyanate-based crosslinking agent, isocyanate groups remain (typically at or above 1%) even after 10 hours (or after 20 hours, or even after 30 hours) from the start of measurement. The water-stable isocyanate-based crosslinking agent preferably has an isocyanate group remaining rate of 50% or higher (e.g. 80% or higher, typically 90% or higher) after 5 hours (or after 10 hours, or even after 20 hours) from the start of measurement.

The water-stable isocyanate-based crosslinking agent include products of DIC Corporation under trade names BURNOCK DNW-5000, BURNOCK DNW-5010, BURNOCK DNW-5100, BURNOCK DNW-5200 and BURNOCK DNW-5500; products of Nippon Polyurethane Industry Co., Ltd., under trade names AQUANATE 100, AQUANATE 105, AQUANATE 110, AQUANATE 120, AQUANATE 130, AQUANATE 200, AQUANATE 210; products of Mitsui Chemicals & SKC Polyurethanes Inc., under trade names TAKENATE WD-220, TAKENATE WD-240, TAKENATE WD-720, TAKENATE WD-725, TAKENATE WD-726, TAKENATE WD-730, TAKENATE WB-700, TAKENATE WB-720 and TAKENATE WB-920; products of Dai-ichi Kogyo Seiyaku Co., Ltd., under trade names ELASTRON BN-04, ELASTRON BN-11, ELASTRON BN-27, ELASTRON BN-69 and ELASTRON BN-77, etc. These can be used singly as one species or in a combination of two or more species.

The amount of the crosslinking agent disclosed herein is not particularly limited. From the standpoint of improving the PSA properties such as removability, repulsion resistance and holding power in a well-balanced manner, it is suitably 0.001 to 10 parts by weight relative to 100 parts by weight of the PSA polymer, or preferably 0.01 to 5 parts by weight (e.g. 0.05 to 3 parts by weight, typically 0.1 to 2 parts by weight).

The water-dispersed PSA composition disclosed herein may further comprise a tackifier. As the tackifier, can be used one, two or more species selected from various tackifier resins such as rosin-based resins, rosin derivative resins, petroleum-based resin, terpene-based resins, phenol-based resins, ketone-based resins. Particularly preferable tackifiers include rosin-based resins, rosin derivative resins and terpene-phenol-based resins.

A preferable example of the tackifier is a stabilized rosin ester resin. As the rosin ester resin, it is possible to use a rosin ester obtained by subjecting a starting rosin to stabilization treatment such as disproportionation and hydrogenation and to purification treatment and further esterifying the stabilized rosin with an alcohol. Examples of such commercial water-dispersed tackifier include products of Arakawa Chemical Industries, Ltd., under trade names SUPER ESTER E-720 and SUPER ESTER E-730-55; and products of Harima Chemicals Group, Inc., under trade names HARIESTER SK-90D, HARIESTER SK-70D, HARIESTER SK-70E and NEOTALL 115E, etc.

Other preferable examples of the tackifier include terpene-phenol-based resins obtainable by phenol modification of terpene-based resins such as α-pinene polymer, β-pinene polymer and diterpene polymer. Commercial terpene-phenol-based tackifiers (possibly in aqueous emulsion forms) that can be preferably used include TAMANOL E-100, TAMANOL E-200 and TAMANOL E-200NT available from Arakawa Chemical Industries, Ltd.

The softening point of the tackifier disclosed herein is not particularly limited. For instance, a tackifier having a softening point in a range of 80° C. to 180° C. can be preferably used. From the standpoint of combining PSA properties such as adhesive strength and repulsion resistance with cohesion (e.g. holding power in a high temperature environment) at a high level, the softening point of the tackifier is preferably 120° C. or higher (e.g. 140° C. or higher).

When using a tackifier, its amount used is not particularly limited. For instance, to 100 parts by weight of the PSA polymer, it can be 1 part by weight or greater. From the standpoint of obtaining the effect of the use of tackifier to a greater extent, it is preferably 5 parts by weight or greater (e.g. 15 parts by weight or greater, typically 25 parts by weight or greater). From the standpoint of reducing the influence on the repulsion resistance, the amount of tackifier used to 100 parts by weight of the PSA polymer is suitably 100 parts by weight or less, or usually preferably 60 parts by weight or less (e.g. 50 parts by weight or less, typically 40 parts by weight or less).

### (Aqueous Solvent)

The water-dispersed PSA composition disclosed herein comprises an aqueous solvent as the solvent. The water-dispersed PSA composition is typically a PSA composition comprising a PSA polymer dispersed in an aqueous solvent. The aqueous solvent in the water-dispersed PSA composition disclosed herein refers to water or a solvent mixture comprising water as the primary component (a component accounting for more than 50% by weight). The other solvent(s) forming the solvent mixture besides water can be one, two or more species selected from various water-miscible organic solvents (lower alcohols, etc.). In the aqueous solvent in this description, the water content is typically 90% by weight or higher, or preferably 95% to 100% by weight.

The PSA composition disclosed herein may contain an acid or a base (aqueous ammonia, etc.) used for pH adjustment and so on. Examples of other optional components that can be contained in the composition include various additives generally used in the field of water-dispersed PSA compositions, such as viscosity-adjusting agent, leveling agent, plasticizer, filler, colorant including pigment and dye, etc., stabilizing agent, preservative, anti-aging agent, and so on. With respect to these various additives, those heretofore known can be used according to typical methods. Since these do not particularly characterize the present invention, detailed descriptions are omitted.

### <PSA Sheet>

### (Constitution of PSA Sheet)

This description provides an adhesively double-faced PSA sheet comprising a PSA layer formed from a water dispersed PSA composition disclosed herein. It may be an on-substrate PSA sheet having such a PSA layer on each face of a substrate (support), or a substrate-free PSA sheet having the PSA layer retained on a release liner (which can be considered as a substrate having a release surface). The concept of the PSA sheet referred to herein encompasses those called as PSA tapes, PSA films, and so on. Although the PSA layer is typically formed in a continuous manner, it is not limited to such a form and it can be formed into, for example, a regular or random pattern of dots, stripes, and so on. The PSA sheet provided by the present invention may be in a roll or in a flat sheet. Alternatively, the PSA sheet can be processed into various other forms.

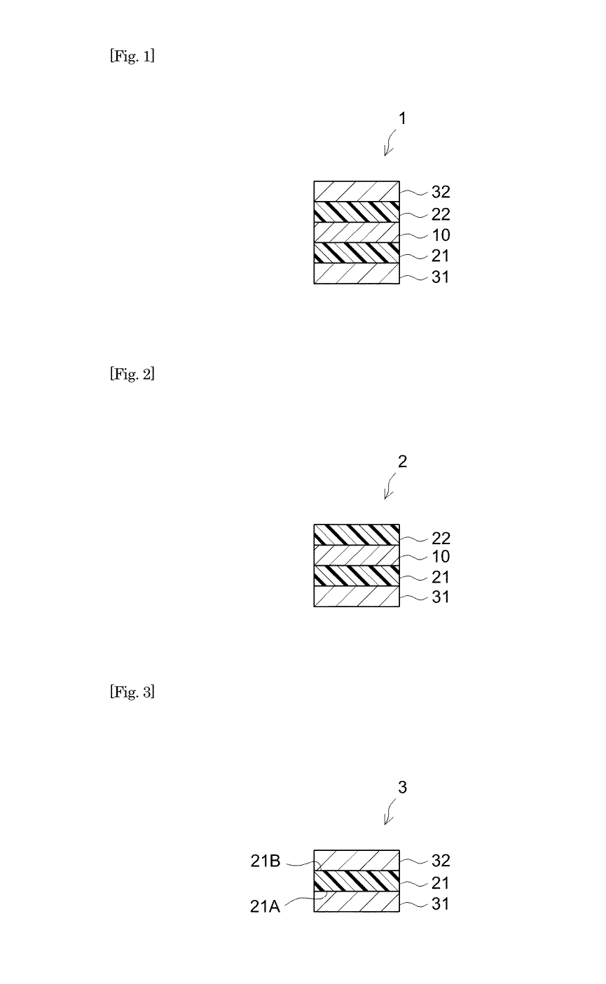

The PSA disclosed herein may have, for example, cross-sectional constitutions schematically illustrated in FIG. 1 to FIG. 4. Among these, FIG. 1 and FIG. 2 show examples of constitutions of an adhesively double-faced on-substrate PSA sheet. PSA sheet 1 illustrated in FIG. 1 has a constitution in which PSA layers 21 and 22 are provided, respectively, on two faces (both non-releasable) of a substrate 10 and the PSA layers 21 and 22 are protected, respectively, with release liners 31 and 32. PSA sheet 2 illustrated in FIG. 2 has a constitution in which PSA layers 21 and 22 are provided, respectively, on two faces (both non-releasable) of a substrate 10 and PSA layer 21 as one of the two is protected with a release liner 31 having a release surface on each face. This type of PSA sheet 2 can be configured so that PSA layer 22 is also protected with release liner 31 by winding the PSA sheet to allow the other PSA layer 22 to contact the back face of release liner 31.

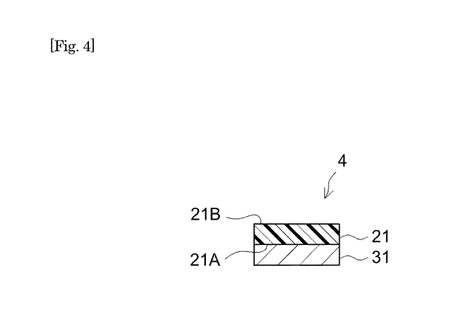

FIG. 3 and FIG. 4 show examples of constitution of a substrate-free double-faced PSA sheet. PSA sheet 3 illustrated in FIG. 3 has a constitution in which two faces 21A and 21B of a substrate-free PSA layer 21 are protected, respectively, with release liners 31 and 32 each having a release surface at least on the PSA layer side. PSA sheet 4 illustrated in FIG. 4 has a constitution such that one surface (adhesive face) 21A of a substrate-free PSA layer 21 is protected with a release liner 31 having a release surface on each face; and when this is wound, the other surface (adhesive face) 21B of PSA layer 21 contacts the back face of release liner 31 so that the other surface 21B is also protected with release liner 31.

### (PSA Layer)

The PSA layer disclosed herein is formed from a water dispersed PSA composition. The weight ratio G_{B} of ethyl acetate-insoluble portion in the PSA layer (crosslinked PSA, in particular, the PSA layer in a fabricated PSA sheet) is preferably 15% to 45%. With the G_{B} being in this range, PSA properties such as adhesive strength and repulsion resistance can be favorably combined with holding power. In addition to the G_{A} of the PSA polymer in the water dispersed PSA composition being in the range of 10% to 50%, when the crosslinked PSA has a G_{B} in this range, the removability can be improved while maintaining the repulsion resistance at a high level.

When the art disclosed herein is implemented with the use of an isocyanate-based crosslinking agent, a low G_{B} in relation to G_{A} means that the crosslinked structure formed by the crosslinking agent (e.g. isocyanate-based crosslinking agent) is poorly developed in the aggregate structure of the PSA. Accordingly, too low a G_{B} tends to lower the removability attained by the use of the crosslinking agent (e.g. isocyanate-based crosslinking agent). When the PSA sheet comprises the PSA layer on the surface of a resin film substrate, the tightness of adhesion (anchoring) between the resin film substrate and the PSA layer tends to decrease. Too high a weight ratio G_{B} has a tendency to bring about excessively large cohesive strength of the PSA and lower the properties such as adhesive strength and repulsion resistance. The G_{B} is preferably 16% or higher (e.g. 18% or higher, typically 20% or higher). The G_{B} is preferably 40% or lower (e.g. 35% or lower, typically 30% or lower). Such a G_{B} can be obtained by adjusting the type and amount of crosslinking agent and so on. The G_{B} is measured by the following method. The same applies to the G_{B} in Examples described later.

[Method for Measuring Weight Ratio G_{B} of Ethyl Acetate-Insoluble Portion of PSA]

The G_{B} can be measured by the same method as for the G_{A} measurement, using approximately 0.1 g of the crosslinked PSA in place of the approximately 0.1 g of the PSA polymer in the G_{A} measurement. The crosslinked PSA can be collected, for instance, from a PSA layer (e.g. a PSA layer formed by applying the water dispersed PSA composition to a substrate or the like and heating it at 120° C. for 30 minutes). In Examples described later, the first PSA layer is removed with toluene. The resulting PSA sheet (weight W_{A}) formed of the substrate and second PSA layer is immersed in ethyl acetate under the same conditions as the G_{A} measurement and the weight (weight W_{B}) of the package containing the ethyl acetate-insoluble portion is measured. The weight (W_{C}) of the substrate is subtracted from each of the weights W_{A} and W_{B} to determine G_{B}. Specifically, G_{B} is determined by substituting the respective values into the following equation:

G_{B} (%)=[(W_{B}−W2−W3−W_{C})/(W_{A}−W_{C})]×100

In the equation, W2 and W3 are the weight of the porous polytetrafluoroethylene membrane and the weight of the twine in the G_{A}, respectively.

From the standpoint of increasing the removability, the PSA disclosed herein preferably satisfies the equation: G_{B} (%) −G_{A} (%)×W_{P} (%)×10⁻²>0. G_{A} (%) and G_{B} (%) are as defined above. WP refers to the weight ratio (%) of the PSA polymer in the non-volatiles of the PSA composition (typically the PSA layer). The G_{B} (%)−G_{A} (%)×W_{P} (%)×10⁻² is more preferably greater than 1 (e.g. 3, typically 5). From the standpoint of reducing the lowering of repulsion resistance, the PSA disclosed herein preferably satisfies the equation: G_{B} (%)−G_{A} (%)×W_{P} (%)×10-2<35. The G_{B} (%)−G_{A} (%)×W_{P} (%)×10⁻² is more preferably 25 or less (e.g. 20 or less, typically 10 or less).

The thickness of the PSA layer (each PSA layer when comprising the first and second PSA layers) disclosed herein is not particularly limited and can be suitably selected in accordance with the purpose. Usually, the thickness of the PSA layer is suitably about 3 μm to 200 μm, or preferably about 5 μm to 150 μm. In view of the internal space of the mobile electronic device to which it is applied, the thickness of the PSA layer is preferably 10 μm to 100 μm, or more preferably 12 μm to 80 μm. The PSA sheet disclosed herein can produce excellent drop impact resistance and holding power even in an embodiment comprising a PSA layer as thin as less than 50 μm (e.g. less than 30 μm, typically less than 20 μm). When the PSA sheet disclosed herein comprises PSA layers (the first and second PSA layers) on both faces of a substrate, the first and second PSA layers may have the same thickness or different thicknesses.

The PSA layer disclosed herein can be formed by a heretofore known method. For instance, a direct method can be used where the PSA composition is directly provided (typically applied) to a substrate and allowed to dry to form a PSA layer. Alternatively, a transfer method can be employed where the PSA composition is provided to a releasable surface (release face) and allowed to dry to form a PSA layer on the surface and the PSA layer is transferred to a substrate. For the release face, a release liner surface, the substrate's back face treated with a release agent and the like can be used. When the PSA sheet is a double-faced PSA sheet comprising a PSA layer on each face of a substrate, each of the first and second PSA layers may be a PSA layer disclosed herein, or only one of the first and second PSA layers may be a PSA layer disclosed herein with the other layer being a heretofore known PSA layer. From the standpoint of increasing the anchoring to a resin film substrate, the PSA layer disclosed herein is preferably formed by applying the direct method, directly applying the composition to the resin film substrate.

The PSA composition can be applied, using a commonly known or used water such as a gravure roll coater, reverse roll coater, kiss roll coater, dip roll coater, die water, bar coater, knife coater and spray coater. Alternatively, the PSA composition can be applied by impregnation, a curtain coating method, etc.

From the standpoint of accelerating the crosslinking reaction and increasing the productivity, etc., the PSA composition is preferably dried with heat. The drying temperature can be, for instance, about 40° C. to 150° C., or usually preferably about 60° C. to 130° C. After dried, the PSA composition may be aged for purposes such as adjusting the migration of components in the PSA layer, progressing the crosslinking reaction, and relieving deformation possibly present in the substrate and PSA layer, etc.

### (Substrate)

In the on-substrate PSA sheet, as the substrate to support (back) the PSA layers, various types of substrate sheet can be used. As the substrate, resin film, paper, fabrics, rubber sheets, foam sheets, metal foil, a composite of these and the like can be used. Examples of resin film include polyolefin film such as polyethylene (PE), polypropylene (PP), ethylene-propylene copolymers; polyester film such as PET, polyethylene naphthalate (PEN); vinyl chloride resin film; vinyl acetate resin film; polyimide resin film; polyamide resin film; fluorine resin film; cellophane and the like. Examples of paper include Japanese paper, Kraft paper, glassine paper, high-grade paper, synthetic paper, top-coated paper and the like. Examples of fabrics include woven fabric and non-woven fabric of pure or blended yarn of various fibrous materials, etc. Examples of the fibrous materials include cotton, staple cloth, Manila hemp, pulp, rayon, acetate fiber, polyester fiber, polyvinyl alcohol fiber, polyamide fiber, polyolefin fiber, etc. Examples of rubber sheets include natural rubber sheets, butyl rubber sheets, etc. Examples of foam sheets include polyurethane foam sheets, polychloroprene rubber foam sheets, etc. Examples of metal foil include aluminum foil, copper foil, etc. In particular, from the standpoint of the size stability, thickness precision, costs, workability, tensile strength, etc., resin films are preferable. Among resin films, a polyester film is particularly preferable. In this description, the “resin film” is typically a non-porous film and it is conceptually distinguished from so-called non-woven and woven fabrics.

The face (PSA layer-side surface) of the substrate (e.g. resin film, a rubber sheet, a foam sheet, etc.) to which the PSA layer is placed may be subjected to a known or commonly used surface treatment such as corona discharge treatment, plasma treatment, UV ray irradiation, acid treatment, alkaline treatment and primer coating. Such a surface treatment may be provided to increase the tightness of adhesion between the substrate and PSA layer, in other words, the anchoring of the PSA layer to the substrate. For the PSA layer side surface of the substrate, a surface treatment that incorporates a polar group such as hydroxy group (—OH group) can be preferably used. Alternatively, the substrate may not be subjected to a surface treatment to increase the anchoring on the PSA layer side surface. By using a PSA layer formed from the water-dispersed PSA composition disclosed herein, excellent anchoring can be obtained even to a substrate provided with no surface treatment (a non-surface-treated substrate).

The art disclosed herein can be preferably implemented in an embodiment where the PSA layer is placed on a surface of a resin film substrate such as a polyester film substrate. The PSA sheet according to a preferable embodiment is an adhesively double-faced PSA sheet comprising a resin film substrate, a first PSA layer placed on a first face of the substrate and a second PSA layer placed on a second face of the substrate. In general, with respect to PSA formed from a water dispersed PSA composition, it is hard to obtain anchoring to resin film substrates, in particular, to polyester film substrates such as PET. However, when the PSA formed from the water dispersed PSA composition disclosed herein comprises an isocyanate-based crosslinking agent, the PSA may bring about excellent anchoring to resin film substrates, in particular, polyester film substrates. Thus, by applying the PSA, excellent removability can be provided to a PSA sheet comprising a resin (preferably polyester) film substrate and a PSA layer placed at least on a surface of the substrate. With the use of a resin film as the substrate, the PSA sheet may have greater workability and excellent thickness precision. To the resin film substrate, as necessary, various additives can be added, such as filler (inorganic filler, organic filler, etc.), anti-aging agent, antioxidant, UV absorber, antistatic agent, lubricant, plasticizer and colorant (pigment, dye, etc.).

The thickness of the substrate is not particularly limited and can be suitably selected in accordance with the purpose. It is generally 1 μm to 500 μm or preferably 3 μm to 200 μm. When using resin film as the substrate, from the standpoint of the repulsion resistance, for instance, a 5 μm to 50 μm thick substrate can be preferably used. When the resin film is a transparent resin film, with such a thickness, the PSA sheet may also have excellent transparency. With the substrate thickness being as thin as less than 30 μm (e.g. less than 20 μm, typically less than 10 μm), removability and repulsion resistance can be combined at a high level.

### (Release Liner)

As the release liner, any conventional release paper or the like can be used without any particular limitations. For example, a release liner having a release layer on a surface of a liner substrate such as resin film and paper; a release liner formed from a poorly-adhesive material such as a fluorine-based polymer (polytetrafluoroethylene, etc.) or a polyolefin-based resin (polyethylene, polypropylene, etc.); or the like can be used. The release layer can be formed, for instance, by subjecting the liner substrate to a surface treatment with a release agent such as a silicone-based, a long-chain alkyl-based, a fluorine-based, a molybdenum disulfide-based release agent or the like.

The overall thickness of the PSA sheet disclosed herein (which can include PSA layers and a substrate, but no release liner) is not particularly limited. It is suitably in a range of about 5 μm to 1000 μm. In view of the PSA properties, etc., the overall thickness of the PSA sheet is preferably about 10 μm to 500 μm (e.g. 15 μm to 300 μm, typically 20 μm to 200 μm). The PSA sheet disclosed herein can produce excellent drop impact resistance and holding power even when the overall thickness is as thin as less than 100 μm (e.g. less than 70 μm, typically less than 50 μm).

### (Properties of PSA Sheet)

The PSA sheet disclosed herein preferably has a 180° peel strength to a polycarbonate (PC) plate (to-PC adhesive strength) of 8 N/20 mm or greater. The to-PC adhesive strength is more preferably 10 N/20 mm or greater (e.g. 12 N/20 mm or greater). For example, an adhesively double-faced PSA sheet (double-faced PSA sheet) that has at least one adhesive face exhibiting such to-PC adhesive strength can be preferably used with the benefit of the high adhesive strength for semi-permanently fastening a component of a mobile electronic device. The to-PC adhesive strength is measured by the method described later in Examples.

The PSA sheet disclosed herein may exhibit impact resistance such that in an impact resistance test, the number of drops executed before an acrylic plate falls off a polycarbonate plate in a drop test at room temperature is 10 or greater. It is more preferable that in the impact resistance test, no fall occurs even after 18 drops at room temperature. It is yet more preferable that when dropped again at −5° C. after 18 drops at room temperature, the number of drops taken before the occurrence of a fall is 3 or greater (5 or greater). The impact resistance test is carried out by the method described later in Examples.

The PSA sheet disclosed herein preferably has one hour or longer holding time in a 40° C. holding power test carried out with a 500 g load applied. The PSA sheet disclosed herein more preferably has a displacement distance of 5 mm or smaller from the initial position after one hour in the 40° C. holding power test. The PSA sheet satisfying these properties may combine removability and holding power at a high level in an embodiment comprising a water dispersion-based PSA layer. The displacement distance is more preferably 2 mm or smaller (e.g. 1 mm or smaller, typically 0.5 mm or smaller). The 40° C. holding power test is carried out by the method described later in Examples.

The PSA sheet disclosed herein preferably exhibits a lifting distance of 10 mm or less after 24 hours at 23° C. in a repulsion resistance test. The lifting distance is more preferably 5 mm or less (e.g. 3 mm or less). The repulsion resistance test is carried out by the method described later in Examples. The PSA sheet disclosed herein preferably does not leave adhesive residue on the adherend in a removability test. The removability test is carried out by the method described later in Examples.

From the standpoint of the environmental health, for the PSA sheet disclosed herein, it is preferable that when the PSA sheet is heated at 80° C. for 30 minutes, the total amount of volatile organic compounds (VOC) released from 1 g of the PSA sheet (which may include a substrate and PSA layers, but no release liner) (or simply the VOC emission hereinafter) is 1000 μg or less (which may be shown in “μg/g” hereinafter). The VOC emission is more preferably 500 μg/g or less (e.g. 300 μg/g or less, typically 100 μg/g or less). When toluene is used as the reference gas, the VOC emission (toluene) is preferably 50 μg/g or less (e.g. 10 μg/g or less, typically 1 μg/g or less). The PSA sheet satisfying these properties can be preferably used for applications that strongly require VOC reduction. The VOC emission is measured based on the VOC measurement test described later in Examples.

Several working examples relating to the present invention are described below, but the present invention is not intended to be limited to these examples. In the description below, “parts” and “%” are based on the weight unless otherwise specified.

### Example 1

### Preparation of PSA Composition

To a reaction vessel equipped with a condenser, nitrogen inlet, thermometer and stirrer, 220.5 parts of ion-exchanged water was placed and allowed to stir under nitrogen flow at 60° C. for at least one hour. To this reaction vessel, was placed 5.0 parts of a polymerization initiator adjusted to a concentration of 10% (i.e. 0.5 part active ingredient). While maintaining the mixture at 60° C., was gradually added dropwise over 4 hours an emulsion formed of 490.8 parts of 2-ethylhexyl acrylate (2EHA), 9.8 parts of acrylic acid (AA), 25.1 parts of a sodium alkyl allyl sulfosuccinate (trade name ELEMINOL JS-20 available from Sanyo Chemical Industries, Ltd.) (40% active ingredient, i.e. 10.0 parts active ingredient), 1.8 parts of t-dodecanethiol (t-LSH for short, available from Wako Pure Chemical Industries, Ltd.) diluted to 10% concentration with 2EHA (i.e. 0.18 part active ingredient) and 146.9 parts of ion-exchanged water. After the completion of addition, the mixture was further maintained at 60° C. for 3 hours. The resulting polymerization reaction mixture was allowed to cool to room temperature and adjusted to pH 7 by adding ammonia water of 10% concentration. As the polymerization initiator, was used 2,2′-azobis[N-(2-carboxyethyl)-2-methylpropionamidine] hydrate (trade nameVA-057 available from Wako Pure Chemical Industries, Ltd.). The ethyl acetate-insoluble portion of the acrylic polymer in the polymerization reaction mixture according to this example had a weight ratio G_{A} of 18.1%. The acrylic polymer had a weight average molecular weight (Mw) in a range of about 110×10⁴ to 143×10⁴, a number average molecular weight (Mn) of about 24×10⁴ and a Mw/Mn value in a range of about 4.5 to 6.0. The acrylic polymer had a glass transition temperature (Tg) of −68.2° C.

To 100 parts of the acrylic polymer in the polymerization reaction mixture, were added 0.5 part of an isocyanate-based crosslinking agent and 30 parts of a tackifier to prepare a water-dispersed PSA composition according to this example. As the isocyanate-based crosslinking agent, was used a water-dispersed polyisocyanate (trade name BURNOCK DNW-5010 available from DIC Corporation). As the tackifier, was used trade name TAMANOL E-200NT available from Arakawa Chemical Industries, Ltd.

### (Fabrication of PSA Sheet)

The resulting water-dispersed PSA composition was applied to a PET release film (trade name DIAFOIL MRF-38 available from Mitsubishi Plastics, Inc.) and allowed to dry at 120° C. for 3 minutes to form a 13 am first PSA layer. The first PSA layer was adhered to a first face of a 5 am thick PET film substrate (trade name LUMIRROR 5AF53 available from Toray Industries, Inc.). Subsequently, to the second face of the PET film substrate, the water dispersed PSA composition was applied and allowed to dry at 120° C. for 3 minutes to form a 13 am thick second PSA layer. The double-faced PSA sheet according to this example was thus fabricated. The ethyl acetate-insoluble portion of the second PSA layer according to this example had a weight ratio G_{B} of 20.8%. Table 1 summarizes this example and the respective examples described below.

### Example 2

The amount of the isocyanate-based crosslinking agent was changed to 1.5 parts relative to 100 parts of the acrylic polymer. Otherwise in the same manner as Example 1, a water dispersed PSA composition was prepared. Using this PSA composition, in the same manner as Example 1, a double-faced PSA sheet according to this example was fabricated. In this example, G_{B} was 33.1%.

### Example 3

As the polymerization initiator, ammonium persulfate (APS for short, available from Wako Pure Chemical Industries, Ltd.) was used in place of VA-057. Otherwise in the same manner as Example 2, a water-dispersed PSA composition was prepared. Using this PSA composition, in the same manner as Example 1, a double-faced PSA sheet according to this example was fabricated. In this example, G_{A} was 59.8% and G_{B} was 43.3%.

### Example 4

The isocyanate-based crosslinking agent was not used. Otherwise in the same manner as Example 1, a water-dispersed PSA composition was prepared. Using this PSA composition, in the same manner as Example 1, a double-faced PSA sheet according to this example was fabricated. In this example, G_{B} was 16.0%.

### Example 5

To a reaction vessel equipped with a condenser, nitrogen inlet, thermometer and stirrer, was placed 170.0 parts of ion-exchanged water and allowed to stir under nitrogen flow at 60° C. for at least one hour. To this reaction vessel, was placed 3.5 parts of ammonium persulfate (available from Wako Pure Chemical Industries, Ltd.) which had been adjusted to 10% concentration with ion-exchanged water. While maintaining the mixture at 60° C., was gradually added dropwise over 4 hours an emulsion formed of 235.2 parts of n-butyl acrylate (BA), 101.9 parts of 2EHA, 10.2 parts of AA, 0.068 part of trimethylolpropane triacrylate (trade name TMP3A available from Osaka Organic Chemical Industry, Ltd.), 29.2 parts of ammonium lauryl sulfate (trade name EMAL AD-25R available from Kao Corporation, 24% active ingredient), 2.8 parts of t-dodecanethiol (t-LSH for short, available from Wako Pure Chemical Industries, Ltd.) diluted to 10% concentration with BA and 100.2 parts of ion-exchanged water. After the completion of addition, the mixture was further maintained at 60° C. for 3 hours. The resulting polymerization reaction mixture was allowed to cool to room temperature and adjusted to pH 7 by adding ammonia water of 10% concentration.

Using the resulting polymerization reaction mixture, but otherwise in the same manner as Example 2, a water dispersed PSA composition was prepared. Using the PSA composition, but otherwise in the same manner as Example 1, a double-faced PSA sheet according to this example was fabricated. In this example, G_{B} was 32.7%.

[180° Peel Strength to Polycarbonate Plate (to-PC Adhesive Strength)]

To the first adhesive face (adhesive face of the first PSA layer) of the double-faced PSA sheet according to each example, was adhered a 25 μm thick PET film (trade name LUMIRROR S10 available from Toray Industries, Inc.). The resultant was cut into a 20 mm wide by 100 mm long size to prepare a measurement sample. In an environment at 23° C. and 50% RH, the second adhesive face (adhesive face of the second PSA layer) of the measurement sample was exposed and the second adhesive face was press-bonded to a polycarbonate plate surface with a 2 kg rubber roller moved back and forth once. This was left standing in the same environment for 30 minutes and measured for peel strength (N/20 mm-width) using a tensile tester, based on JIS 20237, at a peel angle of 180° at a tensile speed of 300 mm/min. As the tensile tester, a universal tensile/compression tester (system name TCM-1 kNB available from Minebea Co., Ltd.) was used. The results are shown in Table 1.

### [Holding Power]

To the first adhesive face (adhesive face of the first PSA layer) of the double-faced PSA sheet according to each example, was adhered a 25 μm thick PET film (trade name LUMIRROR S10 available from Toray Industries, Inc.). The resultant was cut into a 10 mm wide by 100 mm long size to prepare a test piece. The second adhesive face (adhesive face of the second PSA layer) of the test piece was exposed and at room temperature (23° C.), the test piece was press-bonded over a 10 mm wide by 20 mm long bonding area to a Bakelite plate (phenol resin plate) as the adherend with a 2 kg roller moved back and forth once. The test piece thus bonded on the adherend was left standing in the same environment for 30 minutes. Subsequently, the adherend was vertically suspended with the length of the test piece being in the vertical direction. To the free end of the test piece, a 500 g load was applied. Based on JIS 20237, with the load applied, it was left standing in an environment at 40° C. for one hour. After left standing in this manner, the distance that the test piece was displaced (displacement distance) was measured. When the test piece fell off the adherend within one hour, the time required for the fall was recorded. The results are shown in Table 1.

### [Repulsion Resistance Test]

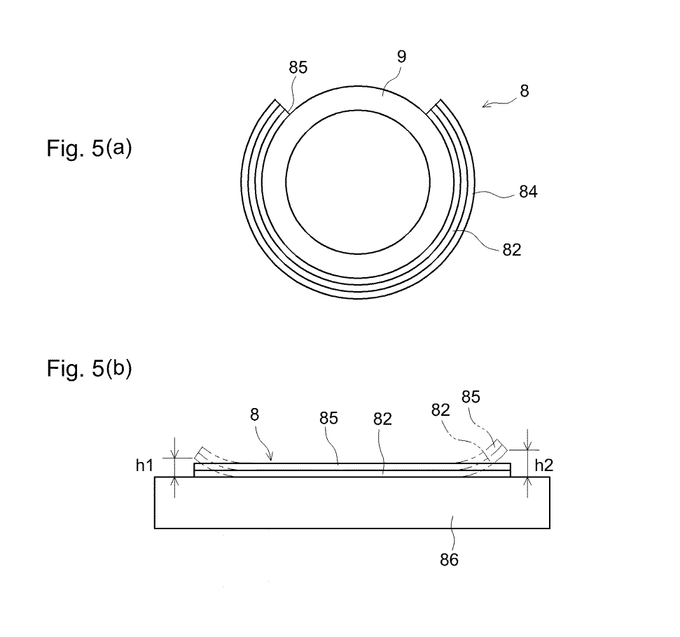

The double-faced PSA sheet according to each example was cut into a 10 mm wide by 90 mm long size while the first and second adhesive faces were protected with the first and second release liners, respectively. From the PSA sheet, the first release liner was removed and the exposed first adhesive face (adhesive face of the first PSA layer) was adhered to a toluene-washed surface of a 10 mm wide by 90 mm long by 0.3 mm thick aluminum plate to prepare a test piece in which the PSA layer was backed with the aluminum plate. The test piece was left standing still at 23° C. for one day. Subsequently, as shown in FIG. 5(a), with the aluminum plate 85-side of test piece 8 being on the inside, the length direction of test piece 8 was curved along the circumference of a cylindrical glass tube 9 of 40 mm diameter for 10 seconds. As shown in FIG. 5(b), the second release liner 84 was then removed from the PSA layer (second PSA layer) 82 of test piece 8 and the adhesive face (second adhesive face) was press-bonded to a pre-washed surface of an acrylic plate (adherend) 86 at a bonding pressure of 0.25 MPa at a bonding speed of 0.3 m/min, using a small laminator available from Taisei Laminator Co., Ltd. After 24 hours at 23° C., as shown by imaginary lines in FIG. 5(b), distances h1 and h2 that the two edges of test piece 8 were lifted from the surface of adherend 86 were measured. The average value between the two edges was determined as the lifting distance of test piece 8. The results are shown in Table 1.

### [Impact Resistance Test]

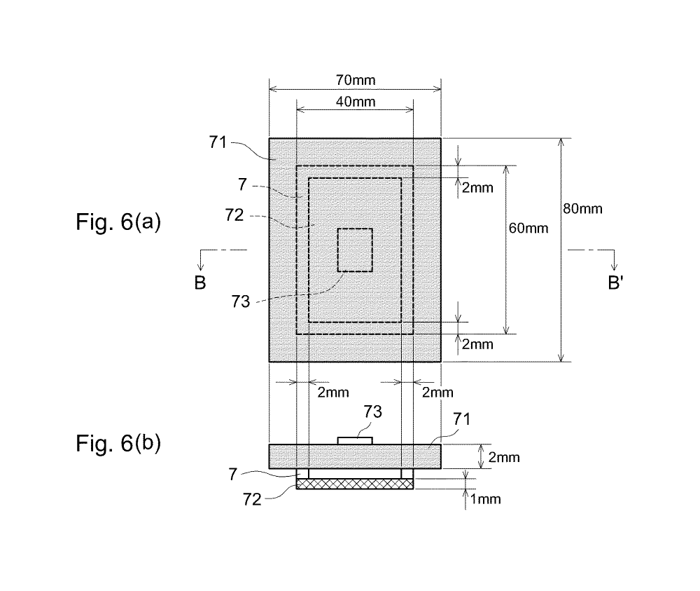

The double-faced PSA sheet according to each example was cut into a frame shape having a 40 mm by 60 mm outer frame and a border width of 2 mm as shown in FIG. 6. With the frame-shape double-faced PSA sheet, a polymethyl methacrylate resin plate (acrylic plate) and a polycarbonate plate (PC plate) were joined together to fabricate a test sample. More specifically, the first adhesive surface of the frame-shape double-faced PSA sheet was adhered to an acrylic plate of 40 mm width, 60 mm length and 1 mm thickness, with a 2 kg roller moved back and forth once. The resultant was left standing at 23° C. for 24 hours. Subsequently, the second adhesive surface of the frame-shape double-faced PSA sheet was adhered to the first face of a PC plate of 70 mm width, 80 mm length and 2 mm thickness, with a 2 kg roller moved back and forth once. Subsequently, a weight was attached to the second face of the PC plate to adjust the weight of the test sample to 110 g.

FIG. 6 shows a schematic drawing of the test sample with (a) showing its upper face and (b) showing a cross section across line B-B′. In FIG. 6, reference numeral 71 indicates the PC plate, numeral 7 indicates the frame-shaped double-faced PSA sheet, numeral 72 indicates the acrylic plate, and numeral 73 indicates the weight for the test sample weight adjustment.

(Room Temperature Drop Test)

At 23° C., the test sample was subjected to 18 repeated rounds of free drop from a height of 1.2 m to a concrete board and the number of drops taken before the acrylic plate fell off the PC plate was recorded. During this operation, the spatial orientation of the test sample was changed so that the underside was alternated among its six faces. In other words, for each of the six faces, a single dropping pattern was repeated three times. When no fall occurred after 18 drops, the sample was subsequently subjected to a low temperature drop test below.

(Low Temperature Drop Test)

The sample after the room temperature drop test was stored in an environment at −5° C. for 30 minutes. Subsequently, the sample was subjected to repeated rounds of free drop from a height of 1.2 m to a concrete board in the −5° C. environment and the number of drops taken before the acrylic plate fell off the PC plate was recorded. During this operation, the spatial orientation of the test sample was changed so that the underside was alternated among its six faces.

The impact resistance test was performed with three test samples (i.e. n=3) for the PSA sheet according to each example, and the impact resistance was evaluated based on the average value of the number of drops. The results obtained are shown in Table 1. In this test, a sample that did not fall off in the room temperature drop test and took 5 or more drops before its fall in the low temperature drop test is graded “Excellent” in practical point of view. From the same viewpoint, a sample that did not fall off in the room temperature drop test and took fewer than 5 drops before its fall in the low temperature drop test is graded “Good”; a sample that took 10 or more, but fewer than 18 drops before its fall in the room temperature drop test is graded “Acceptable”; and a sample that took fewer than 10 drops before its fall in the room temperature drop test is graded “Poor.” In the parentheses, the actual numbers of drops before the fall are shown in the order for the room temperature drop test followed by the low temperature drop test.

### [Removability Test]

To the first adhesive face of the double-faced PSA sheet according to each example, was adhered a 25 μm thick PET film (trade name LUMIRROR S10 available from Toray Industries, Inc.). The resultant was cut into a 20 mm wide by 100 mm long size to prepare a measurement sample. In an environment at 23° C. and 50% RH, the second adhesive face of the measurement sample was exposed and press-bonded to a stainless steel plate (SUS304BA plate) as the adherend with a 2 kg rubber roller moved back and forth once. The measurement sample was stored at 80° C. for 5 days. Subsequently, in an environment at 23° C. and 50% RH, using a tensile tester, the sample was removed from the adherend (SUS plate) at a tensile speed of 300 mm/min, at a peel angle of 180°. The states of the PSA sheet and adherend after the removal were observed and the removability was graded to the following two levels:

Good: No leftover adhesive residue was found on the adherend.

Poor: Leftover adhesive residue was observed on the adherend.

As the tensile tester, a universal tensile/compression tester (system name TCM-1 kNB available from Minebea Co., Ltd.) was used. The results are shown in Table 1.

### [VOC Measurement Test]

From the double-faced PSA sheets according to Examples 1 and 2, 5 cm′ sections (two 1 cm by 2.5 cm pieces of the double-faced PSA sheets) were cut out. After the release liners were removed, they were placed in vials (20 mL) and sealed. The vials were then stored at 80° C. for 30 minutes, using a head space sampler (HSS system). At the same temperature, a 1 mL sample of the gas inside each vial was collected and injected into a gas chromatography (GC system) for measurement to determine the weight of toluene gas formed. The weight was converted to the weight (μg) per gram of double-faced PSA sheet (excluding any release liner) and the value was used as the VOC emission (toluene) (μg/g). Thus, this test is a VOC measurement test that uses toluene as the reference gas. The weight of toluene gas was determined from the value computed from the calibration curve of acetone (or toluene) that had been prepared beforehand. The HSS and GC settings were as follows. It is noted that when measuring the total VOC, the total weight of not just toluene but all the gas formed can be measured in the same manner as for the toluene gas.

HSS: model number “7694” available from Agilent Technologies

Heating time: 30 min

Pressurization time: 0.12 min

Loop filling time 0.12 min

Loop equilibration time: 0.05 min

Injection time: 3 min

Sample loop temperature: 160° C.

Transfer line temperature: 200° C.

GC system: model number “6890” available from Agilent Technologies

Column: J&W capillary column under trade name “DB-ffAP” available from GL Science (0.533 mm inner diameter×30 m length, 1.0 μm thick membrane)

Column temperature: 250° C. (The temperature was raised at 10° C./min from 40° C. to 90° C., followed at 20° C./min to 250° C. and maintained there for 5 minutes.)

Column pressure: 24.3 kPa (constant flow mode) Carrier gas: helium (5.0 mL/min)

Injection port: split (split ratio 12:1)

Injection port temperature: 250° C.

Detector: FID

Detector temperature: 250° C.

TABLE 1

| | | Example | | | | |
|---|---|---|---|---|---|---|
| | | 1 | 2 | 3 | 4 | 5 |
| Polymer | 2EHA | 100 | 100 | 100 | 100 | 30 |
| (parts*) | BA | 0 | 0 | 0 | 0 | 70 |
| | TMP3A | — | — | — | — | 0.02 |
| | AA | 2 | 2 | 2 | 2 | 3 |
| | VA-057 | 0.1 | 0.1 | 0 | 0.1 | 0 |
| | APS | 0 | 0 | 0.1 | 0 | 0.1 |
| | Eleminol JS-20 | 2 | 2 | 2 | 2 | 0 |
| | EmalAD-25R | 0 | 0 | 0 | 0 | 2 |
| | t-LSH | 0.035 | 0.035 | 0.035 | 0.035 | 0.08 |
| Polymer Tg (° C.) | | −68.2 | −68.2 | −68.2 | −68.2 | −57.0 |
| Crosslinking agent | Burnock DNW5010 | 0.5 | 1.5 | 1.5 | 0 | 1.5 |
| (parts*) | | | | | | |
| Tackifier | Tamanol E-200NT | 30 | 30 | 30 | 30 | 30 |
| (parts*) | | | | | | |

| | | | | | |
|---|---|---|---|---|---|
| G_{B} (%) | 20.8 | 33.1 | 43.3 | 16.0 | 32.7 |
| To-PC adhesive strength (N/20 mm) | 12.6 | 13.0 | 9.4 | 10.6 | 9.9 |
| Holding power | 0.55 mm | 0.18 mm | 0.10 mm | 24 min | 0.40 mm |
| Repulsion resistance (mm) | 2.4 | 3.0 | 12.4 | 1.4 | 1.3 |
| Drop impact resistance | (18/4) | (18/6) | (18/2.7) | (18/3) | (3.7/—) |
| (# at 23° C./# at −5° C.) | | | | | |
| Removability | Good | Good | Good | Poor | Good |

*For the components used in the polymer synthesis, the relative values are shown with the combined amount of 2EHA and BA being 100 parts. The crosslinking agent and tackifier are shown in parts per 100 parts of the polymer (phr).

As shown in Table 1, with respect to Examples 1 to 3 using a PSA polymer having a Tg of −60° C. or below along with a crosslinking agent, excellent drop impact resistance and great holding power were obtained. On the other hand, in Example 4 that did not use a crosslinking agent, the holding power decreased. Example 5 using a PSA polymer with a Tg above −60° C. resulted in inferior drop impact resistance. While not specifically shown in the table, the VOC emissions (toluene) of the PSA sheets according to Examples 1 and 2 were both about 0.7 μg per gram of double-faced PSA sheet (excluding any release liner).

Although specific embodiments of the present invention have been described in detail above, these are merely for illustrations and do not limit the scope of the claims. The art according to the claims includes various modifications and changes made to the specific embodiments illustrated above.

### REFERENCE SIGNS LIST

1, 2, 3, 4 PSA sheets
10 substrate
21, 22 PSA layers
31, 32 release liners

1. An adhesively double-faced pressure-sensitive adhesive sheet used for fastening a component of a mobile electronic device, the sheet comprising
a pressure-sensitive adhesive layer formed from a water-dispersed pressure-sensitive adhesive composition, wherein
the water-dispersed pressure-sensitive adhesive composition comprises a pressure-sensitive adhesive polymer as its base polymer, and a crosslinking agent, and
the pressure-sensitive adhesive polymer has a glass transition temperature of −60° C. or lower.

2. The pressure-sensitive adhesive sheet according to claim 1, wherein the water-dispersed pressure-sensitive adhesive composition comprises an isocyanate-based crosslinking agent as the crosslinking agent.

3. The pressure-sensitive adhesive sheet according to claim 1,
wherein the pressure-sensitive adhesive layer has a weight ratio G_{B} of ethyl acetate-insoluble portion of 15% to 45%.

4. The pressure-sensitive adhesive sheet according to claim 1, wherein the pressure-sensitive adhesive polymer is an acrylic polymer.

5. The pressure-sensitive adhesive sheet according to claim 4, wherein the acrylic polymer is obtained by polymerizing a starting monomer material comprising an alkyl acrylate having an alkyl group with 5 to 10 carbon atoms at or above 50% by weight.

6. The pressure-sensitive adhesive sheet according to claim 1, further comprising a substrate that supports the pressure-sensitive adhesive layer, the substrate being a resin film substrate.

7. The pressure-sensitive adhesive sheet according to claim 1, having a displacement distance from an initial position of 2 mm or less after one hour in a 40° C. holding power test carried out with a 500 g load applied.

8. The pressure-sensitive adhesive sheet according to claim 1, having a 180° peel strength to a polycarbonate plate of 10 N/20 mm or greater.
